(19) United States
(12) Patent Application Publication
(10) Pub. No.: US 2011/0145592 A1
(43) Pub. Date: Jun. 16, 2011

(54) Virtual Token for Transparently Self-Installing Security Environment

(75) Inventor: Asaf Greiner, Ramat Gan (IL)

(73) Assignee: SafeNet Data Security (Israel) Ltd., Petach Tikva (IL)

(21) Appl. No.: 12/673,295

(22) PCT Filed: Aug. 13, 2008
(86) PCT No.: PCT/IL2008/001111

§ 371 Date: Mar. 3, 2011

Related U.S. Application Data
(60) Provisional application No. 60/955,386, filed on Aug. 13, 2007.

(51) Int. Cl. H04L 9/00

(52) U.S. Cl. 713/189

(57) ABSTRACT

A virtual token for use in a virtual computer environment to implement the secure cryptographic facilities of a hardware security token within a computer without requiring custom installation or administrator privileges. The hardware security token contains an automatic installer for the virtual environment and the virtual token with the computer's operating system. When plugged into the computer the hardware security token automatically performs dynamic installation as necessary, providing secure cryptographic services to standard application programs already installed in the computer. The installation is transparent to the user, and requires no user attention or special access privileges. After the session is completed and the security token is removed from the computer, the virtual environment is effectively uninstalled from the host computer, also transparently to the user, without any user attention, and without making any modifications to the computer's operating system.

### FIELD OF THE INVENTION

The present invention relates to computer security tokens and, more particularly, to a virtual token for a self-installing client environment that is transparent to the user.

### BACKGROUND OF THE INVENTION

The term “security token” herein denotes a personal portable electronic device which contains and protects sensitive and confidential information and which provides security-related services including, but not limited to: privacy, access control, authentication, and data protection. The term “hardware security token” is sometimes used to emphasize the implementation of the security token as a physical device. The term “access” herein denotes authorization to enter a restricted physical location or to obtain and/or modify restricted data or information, computer facilities, or otherwise engage in restricted communications. The term “authentication” herein denotes the establishment and verification of an identity, including, but not limited to the personal identify of the user of a security token. Sensitive and confidential information contained by a security token includes, but is not limited to: usernames, passwords, account numbers, access codes, digital certificates, encryption/decryption keys, security policies, and the like. Sensitive and confidential data capabilities contained by a security token include, but are not limited to: digital signature creation and verification, challenge-response capabilities, username and/or password and/or PIN presentation, one-time password generation, data authentication/validation capabilities, sensitive data storage, and encryption/decryption/hashing capabilities. The sensitive and confidential data information contained in a security token is typically protected by the use of smartcard chip technology. A suitably-configured smartcard may constitute a security token.

One of the principal venues for using a security token is in a personal computer, especially in the case of a personal computer connected to an insecure public network, such as the Internet. Particular uses of a security token on a personal computer include, but are not limited to:
accessing a virtual private network (VPN), a secure virtual network within a public network;
accessing a bank account or other sensitive data via a public network; and
signing, encrypting, verifying, and/or decrypting electronic mail or other documents sent over a public network.

In all of these cases, the personal computer relies on the security token to perform certain cryptographic services. By sending data to the security token for encryption, decryption, hashing, signing, validation, etc., sensitive cryptographic data remains safely in the security token, rather than being sent to the personal computer, which is not necessarily secure, and where the sensitive cryptographic data is vulnerable to compromise and loss of secrecy.

In order to use the security token to provide cryptographic services, however, the personal computer needs to have certain data processing capabilities, embodied in what is generally referred to as a “client environment” for the secure token. A layer diagram of a typical prior-art client environment 100 for a security token or smartcard is illustrated in FIG. 1.

FIG. 1 shows a typical user application program 101 (non-limiting examples of which include: an e-mail client, such as Microsoft “Outlook”; and a web browser, such as Mozilla “Firefox”) that may require cryptographic services from a security token or a smartcard (non-limiting examples of which include: digitally signing an e-mail message with the user's private key; and accessing a restricted website on the Internet). To obtain access to cryptographic and other security services, application program 101 communicates with a cryptographic services provider (CSP) layer 103. CSP layer 103 in turn communicates with various lower-level drivers, such as a smartcard driver 105, a hardware token driver 109, or a chip smartcard interface device driver (CCID) 113 to access respective physical devices such as a smartcard 107, a hardware token 111, or a USB smartcard device 115 (such as a smartcard reader or a USB security token). In non-limiting examples of typical prior-art additional device connectivity, application program 101 can also access: a physical removable mass storage device 119 (such as a flash memory unit) via a mass storage device driver 117; and a human interface device 123 (such as a keyboard) via a human interface device driver 121. Both mass storage device driver 117 and human interface device driver 121 typically are standard software components in a modern personal computer operating system.

When a user wishes to employ his or her own personal computer as a client for a security token, the above environment is typically installed on the personal computer, so that when the security token is plugged into the computer, the desired application program has cryptographic access to the security token. In particular, CSP 103 and smartcard driver 105 and optionally hardware token driver 109 must be installed. This is the mode for personal computer operation that is currently employed by users of security tokens. Unfortunately, however, installing CSP 103 in a computer typically requires special administrator privileges because the installation involves making permanent modifications to the computer operating system.

Because security tokens are readily portable, however, there are frequent occasions when a user wishes to employ his or her security token at a different location, with a different personal computer to host the client application program on a temporary basis. In such a case, however, the user is presented with the problem of installing the client environment on the new host computer. Not only is it a time-consuming and bothersome operation to install such an environment on a computer, but as noted, it also requires the user to carry the installation media and it requires that the user have administrator privilege. Furthermore, the owner or administrator of the host computer may not wish the client environment to remain on the computer after the user has completed the temporary access. Thus, the user may have to uninstall the client environment, but despite such removal, modifications to the operating system of the host computer may remain.

There is thus a widely recognized need for, and it would be highly advantageous to have, a security token which does not require the user to actively install and uninstall a client environment on a host computer, which does not require administrator privilege, and which does not modify the operating system. This goal is met by the present invention.

### SUMMARY OF THE INVENTION

The present invention is of a virtual token for use within a virtual environment, which does not require the user to install or uninstall a client environment on a host computer. Embodiments of the present invention include a hardware security token which automatically performs an installation of a virtual token within a virtual environment on the host computer in a manner that is transparent to the user, does not require administrator privileges, and such that the installation is effectively uninstalled when the session is completed and the hardware security token is removed from the computer.

Therefore, according to the present invention there is provided a virtual token for providing a security service to an application program running in a virtual environment within a computer operating system, the virtual environment containing a virtual cryptographic services provider layer for serving the application program, the virtual token including: (a) an interface to the virtual cryptographic services provider layer; (b) a protocol formatter, for formatting data received from the interface and for formatting data sent to the interface; and (c) a hardware security token coupled to the computer and configured to provide the security service via the protocol formatter.

In addition, according to the present invention there is also provided a security token for providing a security service to an application program in a computer operating system, the security token including: (a) a bi-directional data interface to the computer, for exchanging data therewith; (b) a virtual environment loader, configured for loading a virtual environment into the operating system, and wherein the virtual environment includes a virtual cryptographic services provider layer; and (c) an installation script, for installing a virtual token into the virtual environment, wherein the virtual token includes: (d) an interface to the virtual cryptographic services provider layer, for communicating with the application program; and (e) a protocol formatter, for formatting data received from the bi-directional data interface and for formatting data sent to the bi-directional data interface.

### BRIEF DESCRIPTION OF THE DRAWINGS

The invention is herein described, by way of example only, with reference to the accompanying drawings, wherein:

FIG. 1 is a diagram showing the layers of a typical prior-art client environment for a smartcard or secure hardware token.

FIG. 2 is a diagram showing the layers of a virtual client environment containing a virtual token, according to an embodiment of the present invention.

FIG. 3 conceptually illustrates protocol formatter wrapping and unwrapping as employed by embodiments of the present invention.

FIG. 4 conceptually illustrates transparent self-installation of a security environment in a computer by a security token according to embodiments of the present invention.

### DESCRIPTION OF THE PREFERRED EMBODIMENTS

The principles and operation of a virtual token in a virtual client environment as transparently self-installed by a hardware security token according to embodiments of the present invention may be understood with reference to the drawings and the accompanying description.

### Virtual Token

The term “virtual token” herein denotes executable software for a computer which provides the same security-related services to an application program that would be provided by a hardware security token. In embodiments of the present invention, a virtual token communicates with, and operates in conjunction with, an external hardware security token to provide the services.

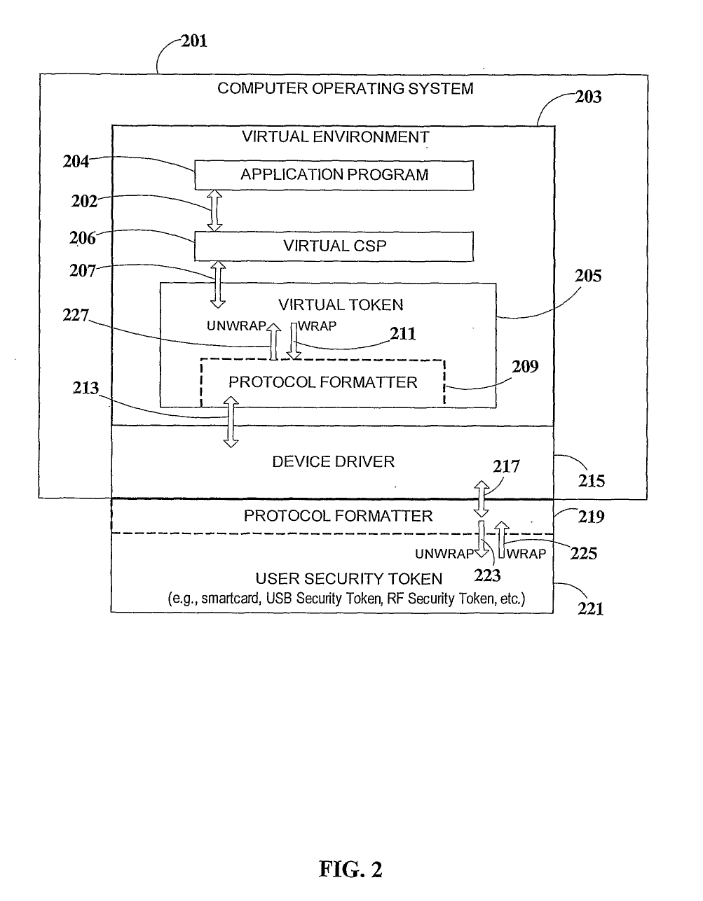

FIG. 2 illustrates the levels of a virtual client environment 203 within a computer operating system 201 of a host computer. A virtual token 205 according to embodiments of the present invention is installed, having an interface 207 to a virtual CSP layer 206 running in virtual environment 203 (as described in more detail below).

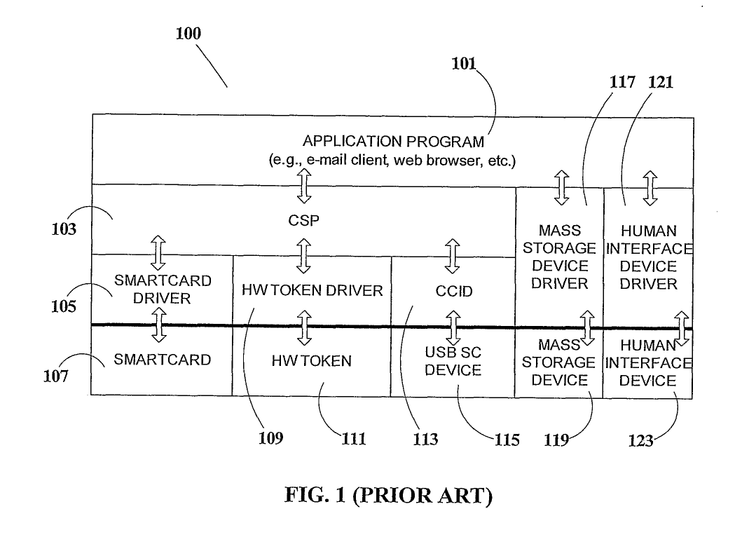

Application program 204 is considered “standard” in that application program 204 is a normal version of an application program intended for computer operating system 201, and has not been specially modified regarding accessibility to security services provided by an external service or device. In a non-limiting example, application program 204 is a standard web browser such as Microsoft “Internet Explorer” or Mozilla “Firefox” without any custom features or modifications. Application program 204 accesses virtual CSP layer 206 via an interface 202. From the standpoint of application program 204, accessing virtual CSP layer 206 is done in exactly the same way as previously illustrated for application program 101 accessing CSP layer 103 (FIG. 1). What is different about CSP layer 206, however, is that no administrator privileges or other special arrangements are necessary to install CSP layer 206 in virtual environment 203. As far as operating system 201 is concerned, virtual environment 203 is just another application program, of which CSP layer 206 is merely a portion, and therefore operating system 201 does not impose any privilege restrictions on installing CSP layer 206. Thus, CSP layer 206 can be loaded automatically during the loading of virtual environment 203.

Virtual environments for computers are known in the art, and are available through sources such as Ceedo Technologies, Ltd., Rosh-Haayin, Israel; InstallFree Inc., Stamford, Conn.; MokaFive, Redwood City, Calif.; Sun Microsystems, Inc., Santa Clara, Calif. (“VirtualBox”); and Citrix Systems, Inc., Ft. Lauderdale Fla. (“XenDesktop”).

Virtual token 205 converts outgoing data in a wrap operation 211 and converts incoming data in an unwrap operation 227 to communicate with protocol formatter 209 via an interface 213. In this manner, virtual token 205 communicates externally via a compatible device driver 215 of operating system 201. In a non-limiting embodiment of the present invention, protocol formatter 209 formats outgoing data for, and receives incoming data from, a mass storage device driver, which is typically included or pre-installed in modern operating systems as a native device driver requiring no installation by the user. That is, in this non-limiting embodiment, device driver 215 is a mass storage device driver. In preferred embodiments of the present invention, device driver 215 is such a pre-installed or native device driver, non-limiting examples of which include not only the mass storage device driver mentioned above, but also human interface device drivers, such as drivers for keyboards. In other embodiments of the present invention, device driver 215 is more specialized. Non-limiting examples of more specialized device drivers include device drivers for dedicated smartcard readers of various types as known in the art.

Also included, but not shown in FIG. 2 is a physical data connection between computer operating system 201 and external user security token 221. Examples of such physical data connection include, but are not limited to: pluggable connectors, such as a USB connector; a Radio Frequency (RF) data link, such as proximity RF, Bluetooth, and the like; and an ISO 7816 smartcard connector.

Device driver 215 has an interface 217 enabling data communications with a compatible external user security token 221. In preferred embodiments of the present invention, security token 221 is compatible with a pre-installed or native device driver of a computer (as discussed above), and includes a protocol formatter 219 therefor. In non-limiting embodiments of the present invention, protocol formatter 219 formats data for compatibility with a mass storage device or a human interface device. Protocol formatter 219 converts data from interface 217 to security token format via an unwrap operation 223, and converts data from security token format to interface format via a wrap operation 225. In other embodiments of the present invention, protocol formatter 219 is included as part of the interface of a smartcard reader.

### Wrapping and Unwrapping Protocol Formats

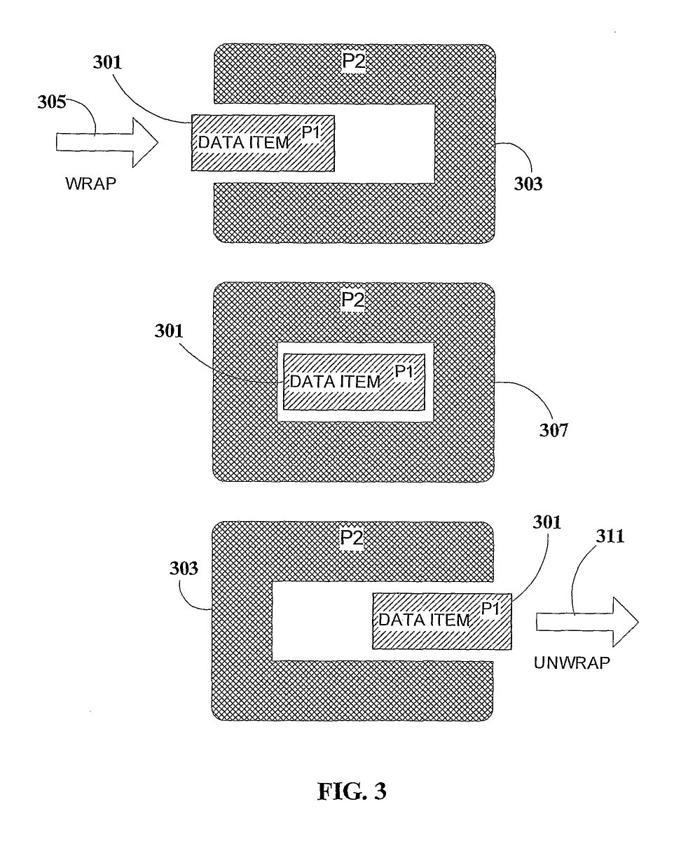

Reference to FIG. 3 is now briefly made to clarify the wrapping and unwrapping operations discussed herein. A data item 301 is formatted in a first protocol P1. Data item 301 can be any data associated with or defined for use with protocol P1, including, but not limited to: command; message; notification; request; response, data argument; and so forth. In a wrapping operation 305, data item 301 is incorporated into a format 303 of a second protocol P2, thereby fouling a data item 307 which conforms to the standards of Protocol P2 and can be transmitted, received, and handled by hardware and software compatible with data in P2 format. Finally, in an unwrapping operation 311, original data item 301 is extracted, and the P2 formatting 303 is discarded. Protocol formatting of this sort is well-known prior art, which enables data in one format (e.g., P1) to be handled by devices and software which does not recognize P1, but works instead via P2.

In the general case of cryptographic protocols, “wrapping” a cryptographic command, request, response, parameter, and data involves reformatting the cryptographic input to appear, in a non-limiting example, as a mass storage access command, request, response, parameter, and data. In a particular instance of this non-limiting example, a cryptographic command to digitally sign a piece of plaintext using the private key of the security token is wrapped (reformatted) to appear to be a “write” command to write the plaintext to a specified location of mass storage. In this case, the specified location of mass storage does not actually exist in the mass storage device (the security token), but the security token is able to interpret this location as being a wrapped command to digitally sign the plaintext using the user's private key (which only the security token has). This command is passed along from virtual token 205 in virtual environment 203 in intact form by operating system 201 via the mass storage driver to security token 221, which appears to operating system 201 as a regular mass storage device. When the command is received by security token 205's protocol formatter 219 (in this non-limiting example, a mass storage device interface), protocol formatter 219 recognizes that the location specified in the command does not exist, and properly interprets the command as a wrapped command. Then, protocol formatter 219 unwraps the command by reformatting into the corresponding cryptographic command, and has user security token 221 digitally sign the plaintext. To return the signed plaintext to virtual token 205, protocol formatter 219 wraps the signed plaintext and returns the data to virtual token 205 via the mass storage device interface for subsequent unwrapping. Virtual token 205 thus receives the signed plaintext, which is passed on to virtual CSP layer 206 and thence to application program 204 in virtual environment 203 of the host computer.

### Virtual Token Operation

In practice, virtual token 205 operates as follows:

When application program 204 requires a security token service (a non-limiting example of which is the encryption of data), application program 204 requests the service from virtual token 205 in the standard manner thereof, through virtual CSP layer 206 via interface 207. In an embodiment of the present invention, virtual token 205 translates the incoming request to a format compatible with external user security token 221, and then wraps the translated request via protocol formatter 209 in wrapping operation 211.

The wrapped translated request of application program 204 is then sent via interface 213 to device driver 215, and thence via interface 217 to protocol formatter 219, which then unwraps the translated request from application program 204 via unwrapping operation 223. User security token 221 then receives the translated request, and provides the requested service. In the non-limiting example mentioned above, this is a request to encrypt data, and security token 221 thus encrypts the data as requested. The response from security token 221 (the encrypted data) is wrapped by protocol formatter 219 via wrapping operation 225 into a format compatible with device driver 215, which receives the wrapped response via interface 217 and takes the wrapped response to protocol formatter 209 via interface 213. Thereafter, protocol formatter 209 unwraps the wrapped response via unwrapping operation 227 and presents the response to virtual token 205, which delivers the response to application program 204.

Thus, application program 204 obtains the required service from virtual token 205, although the service was actually performed by external user security token 221. In this manner, the service is provided securely. In the non-limiting example of data encryption, for instance, the cryptographic keys are kept at all times in user security token 221 and are therefore protected against disclosure and unauthorized use.

### Transparently Self-Installing Security Environment

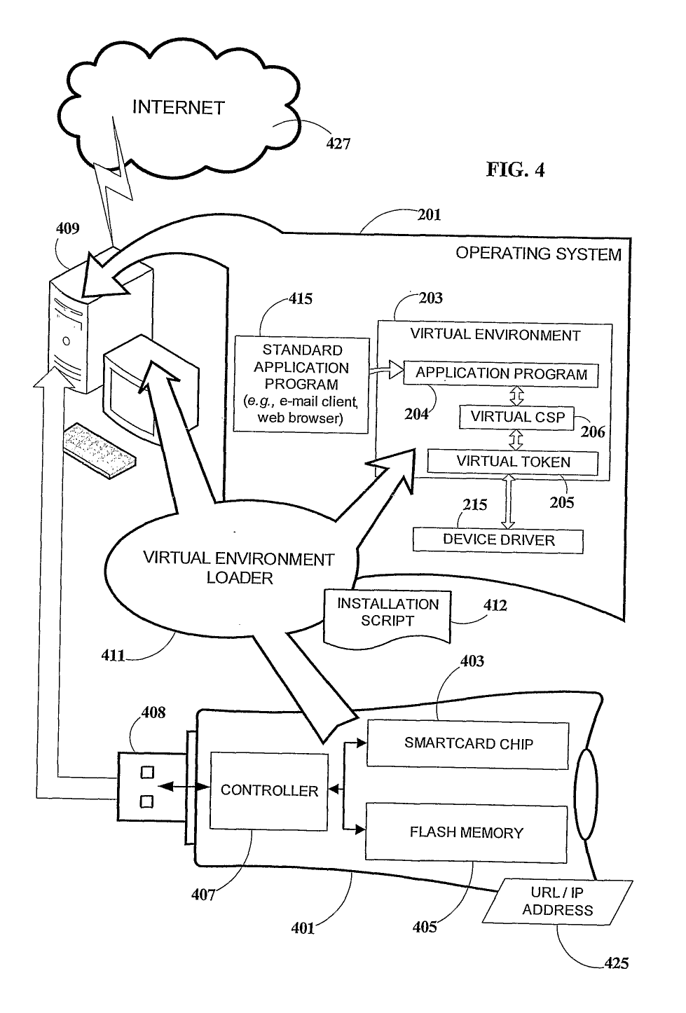

FIG. 4 conceptually illustrates a hardware security token 401 which is configured to automatically install virtual environment 203 with virtual token 205 in operating system 201 (as previously discussed and illustrated in FIG. 2) within a computer 409. As already noted, the installation is transparent to the user in that the user need not perform any special installations or other actions. According to embodiments of the present invention, by merely coupling security token 401 to computer 409 via a bi-directional data interface thereof (in a non-limiting example, by plugging security token 401 into a suitable port on computer 409), the automatic installation is initiated without any further user involvement or notification. Similarly, embodiments of the present invention provide that when the user decouples (in the non-limiting example, by ejecting or unplugging) security token 401 from computer 409, virtual environment 203 and all components and contents thereof are transparently uninstalled from computer 409 without any user notification or attention. These processes furthermore do not result in any modification of operating system 201.

Security token 401 contains a smartcard chip 403, flash memory 405, and a controller 407 for interfacing these to computer 409. According to embodiments of the present invention, security token 401 has a bi-directional data interface to computer 409, whereby data can be exchanged between them. It is over this bi-directional data interface that security token 401 communicates with virtual token 205, via device driver 215. In a preferred, but non-limiting embodiment of the present invention, security token 401 (as illustrated in FIG. 4) is a USB security token having a USB connector 408 for this bi-directional data interface. Other bi-directional data interfaces are featured in other embodiments of the present invention.

Automatic installation as described above is carried out by a virtual environment loader 411 which is executable software stored in security token 401 and run on computer 409. According to embodiments of the present invention, a standard application program 415 which has already been loaded into computer 409 is launched as application program 204. Application program 204 interfaces with virtual token 205 via virtual CSP layer 206 as previously discussed.

In an embodiment of the present invention, virtual environment 203 and all components thereof (including virtual token 205) are loaded into computer operating system 201 from flash memory 405. In another embodiment of the present invention, virtual environment 203 and all components thereof (including virtual token 205) are downloaded into computer operating system 201 via a computer network, such as the Internet 427 according to a Universal Resource Locator (URL) or Internet Protocol (IP) address 425 contained within security token 401, where the URL or IP address is of a resource on the computer network which can download virtual environment 203. According to yet another embodiment of the present invention, some portions of virtual environment 203 are downloaded from the computer network, and remaining portions are loaded from flash memory 405. In a preferred embodiment of the present invention, all of virtual environment 203 (including virtual CSP layer 206) are downloaded from the computer network, and only virtual token 205 is loaded from flash memory 405.

According to embodiments of the present invention, virtual environment loader 411 carries a short installation script 412. In one embodiment security token 401 mimics a mass storage device, such as a CD-ROM, so that when plugged into the USB port of the computer, it appears to the computer as if a mass-storage device, such as a CD-ROM with auto-play capability is now connected. When the auto-play feature is automatically activated by the computer's operating system, installation script 412 is executed.

### Variations for Different Pre-Existing Computer Configurations

For optimal efficiency, it is preferred that the pre-existing configuration of computer 409 be taken into consideration.

According to an embodiment of the present invention, when installation script 412 executes, it first checks to see if a public key infrastructure (PKI) client middleware (a CSP and a smartcard driver) is already installed on computer 409. If this is the case, then computer 409 is already configured to interface to the security token as a cryptographic services provider, and security token 401 then simply identifies itself to the PKI client middleware as a smartcard device having cryptographic capabilities, and the process is essentially complete at this point. All that remains is for security token 401 to launch user application program 415. In an embodiment of the present invention, application program 415 is also automatically launched by installation script 412. In some cases, the application program 415 may need to be configured for the user's preferences (for example, loading the user's “favorites” for the Internet browser).

If, however, there is no PKI client middleware, in another embodiment of the present invention, installation script 412 checks to see if a CCID is already installed on computer 409. If this is the case, then computer 409 is already configured to interface with security token 401 (which is illustrated in FIG. 4 as a USB device), and security token 401 then proceeds, emulating a mass storage device, to install its own PKI virtual client environment. Because the CCID exists on computer 409, however, this installation is relatively simple, requiring only user application program 415 and virtual CSP layer 206. Virtual CSP layer 206 interfaces with the CCID to access security token 401 directly.

According to yet another embodiment of the present invention, if no CCID exists on computer 409, then computer 409 is normally unable to access security token 401 as a smartcard device. In this case, installation script 412 installs a complete virtual client environment 203, as described previously.

While the invention has been described with respect to a limited number of embodiments, it will be appreciated that many variations, modifications and other applications of the invention may be made.

1. A virtual token for providing a security service to an application program running in a virtual environment within a computer operating system, the virtual environment containing a virtual cryptographic services provider layer for serving the application program, the virtual token comprising:
an interface to the virtual cryptographic services provider layer;
a protocol formatter, for formatting data received from said interface and for formatting data sent to said interface; and
a hardware security token coupled to the computer and configured to provide the security service via said protocol formatter.

2. The virtual token of claim 1, wherein said protocol formatter is compatible with a device driver selected from a group consisting of:
a mass storage device;
a human-interface device.

3. The virtual token of claim 1, wherein the security service is selected from a group consisting of
privacy;
access control;
authentication/validation;
data protection;
encryption/decryption/hashing;
digital signature creation/verification;
digital certificate creation/verification;
challenge/response;
username/password/PIN/access code presentation;
one-time password generation;
sensitive data storage.

4. A security token for providing a security service to an application program in a computer operating system, the security token comprising:
a bi-directional data interface to the computer, for exchanging data therewith;
a virtual environment loader, configured for loading a virtual environment into the operating system, and wherein said virtual environment includes a virtual cryptographic services provider layer; and
an installation script, for installing a virtual token into said virtual environment, wherein said virtual token includes:
an interface to said virtual cryptographic services provider layer, for communicating with the application program; and
a protocol formatter, for formatting data received from said bi-directional data interface and for formatting data sent to said bi-directional data interface.

5. The security token of claim 4, further comprising a flash memory, and wherein at least part of said loading a virtual environment is performed via loading from said flash memory.

6. The security token of claim 4, further comprising at least one of:
a Universal Resource Locator of a resource on a computer network; and
an Internet Protocol address of said resource on said computer network;
and wherein at least part of said loading a virtual environment is performed via downloading from said resource.
